(19) United States
(12) Patent Application Publication
(10) Pub. No.: US 2017/0155219 A1
(43) Pub. Date: Jun. 1, 2017

(54) Substitute flange sleeve for alternative mounting of a cylindrical heavy duty deutsch type on-board diagnostic receptacle

(71) Applicant: Geotab Limited, Oakville (CA)

(72) Inventors: Thomas Arthur Wali, Hamilton (CA); John Robert Ford Kyes, Burlington (CA)

(73) Assignee: Geotab Limited

(21) Appl. No.: 14/757,177

(22) Filed: Dec. 1, 2015

(51) Int. Cl. H01R 24/76; H01R 13/627; B60R 16/02

(52) U.S. Cl. CPC H01R 24/76; B60R 16/0207; H01R 13/6272; H01R 2107/00

(57) ABSTRACT

A flanged vehicle-mounting sleeve is provided for use in association with a heavy duty vehicle, chassis-mountable, data bus signal wiring harness coupling. The coupling includes a receptacle having a generally circular cross-section and being adapted to be accommodated in longitudinal pass-through relation by a corresponding vehicle chassis mount including a mounting aperture for the coupling. The receptacle also includes a receptacle-flange engagable in receptacle-flange matching chassis-secured relation with a compatible receptacle-flange chassis mount adjacent the vehicle chassis mounting aperture with the receptacle supported thereby in pass-thru relation with the aperture. The optional sleeve is adapted to be slidably mounted into cooperative engagement in conjoined, axially and radially fixed relation on the receptacle with an alternative sleeve-flange engagable in flange-matching chassis-secured relation adjacent the vehicle chassis mounting aperture with the receptacle supported thereby in pass-thru relation with the aperture.

### FIELD OF THE INVENTION

The present invention relates to vehicle chassis mounting of so-called “Deutsch”, standard cylindrical form-factor data bus wiring harness couplings using a substitute flange mounting sleeve compatible with corresponding original vehicle manufacturer's chassis mountings.

### BACKGROUND OF THE INVENTION

There are significant costs and logistical problems related to the provision of so-called heavy duty wiring harnesses that utilize Deutsch connectors for aftermarket installations of vehicular data bus accessing devices, including for example telematics devices for variously recording and/or transmitting vehicular data. Although the cylindrical form factor associated with such connectors is reasonably standard in the industry, the problems arise in providing for compatible flanges in mounting the connectors on differing manufacturers' vehicles, where the flange provisions for chassis OEM mountings of the in-cab diagnostic link connector can differ.

### SUMMARY OF THE INVENTION

The present invention relates to a sleeve adapted to be paired with a flanged receptacle—and when so paired, to provide an alternative to the receptacle's flange for vehicle mounting of the receptacle.

Accordingly, an aspect of the invention relates to a flanged vehicle-mounting sleeve, for use in association with a heavy duty vehicle, chassis-mountable, data bus signal wiring harness coupling which further includes a receptacle substantially as described herein. The sleeve is adapted to be slidably mounted into cooperative engagement in conjoined, axially and radially fixed relation on the receptacle with the sleeve's flange engagable in flange-matching chassis-secured relation adjacent the vehicle chassis mounting aperture with the receptacle supported thereby in pass-thru relation with the aperture.

In accordance with an aspect of the present invention there is provided a heavy duty vehicle, chassis-mountable, data bus signal wiring harness coupling comprising a flanged receptacle in combination with and an alternatively flanged vehicle-mounting sleeve. The receptacle in such a combination has a generally circular cross-section and is adapted to be accommodated in longitudinal pass-through relation by a corresponding vehicle chassis mounting aperture for the coupling. In addition, the receptacle has a plurality of conductor-receiving, longitudinally-extending bores adapted to be selectively populated by data bus signal wiring and associated contact terminals corresponding in numbering and arrangement to a corresponding heavy duty vehicle's data bus data link connector. More particularly, the receptacle has a mounting flange adapted for, and useful when, the receptacle is employed independently of the combination: to secure the coupling by way of the receptacle flange, to the vehicle chassis mounting. In the combination with the receptacle, the sleeve is adapted to be slidably mounted into cooperative engagement in conjoined, axially and radially fixed relation on the receptacle with the sleeve's flange engagable in flange-matching chassis-secured relation adjacent the vehicle chassis mounting aperture with the receptacle supported thereby in pass-thru relation with the aperture. With the sleeve engaged with the receptacle, the coupling is provided with an alternative (to the receptacle flange) flange for vehicle mountings for which the receptacle flange is incompatible.

The invention furthermore relates to sets or kits comprising a receptacle and one or more alternative flanged sleeves. The sleeve (or sleeves as the case may be), is/are operable to be selectively engaged with the receptacle to thereby provide for alternative, flange-matching chassis-secured relation of the coupling for a particular vehicle application. In other words such a set includes one or more sleeves providing for a corresponding variety of different alternative flanges, respectively suited to differing vehicle chassis installations and from amongst which an installer can select a sleeve with a flange configuration compatible with the instance of a particular installation of the data bus signal wiring coupling on a particular vehicle's chassis mounting.

The invention further relates to the provision of couplings thereof in association with one or more of a plurality of wiring harness termini respectively adapted to provide wiring connections to a corresponding plurality of after-market vehicle data bus accessing devices, and in particular wherein at least one of the termini is adapted to be associated with a vehicle's OEM provision for the vehicle chassis mounted coupling. In such an arrangement, the wiring harness would make provision for a common connection with the vehicular data bus link connector, and various termini respectively serving connections with the divers aftermarket devices.

### INTRODUCTION TO THE DRAWINGS

FIG. 1 depicts an exploded perspective view of a coupling according to the present invention, including a substitute flange sleeve and a receptacle adapted to be mutually paired in an assembled coupling according to the present invention;

FIGS. 2 and 3 depict, respectively, perspective and elevated end views showing a Deutsch type receptacle;

FIG. 3 depicts an elevated side view of the assembled coupling depicted in FIG. 2;

FIG. 4 depicts a perspective view of a sleeve/receptacle assembly of an embodiment of the present invention;

FIG. 5 depicts a “T” wiring harness including a coupling in accordance with one aspect of the present invention.

### DETAILED DESCRIPTION

Referring now to the drawings in general, there are illustrated an elements and arrangements thereof useful in conjunction with a vehicle-mounting substitute flange sleeve 1 for use in association with a heavy duty vehicle, chassis-mountable, data bus signal wiring harness coupling 2 which further includes a receptacle 3.

Receptacle 3 has a generally circular cross-section (and a cylindrical body) and is adapted to be accommodated in longitudinal pass-through relation by a corresponding vehicle chassis mounting aperture for the coupling 2. Receptacle 3 also has a plurality of conductor-receiving, longitudinally-extending bores indicated generally by reference numeral 6, which are adapted to be selectively populated by data bus signal wiring and associated contact terminals with contact terminal fixture 3a, seal 3b and back collar 3c. The population of terminals variously correspond in numbering and arrangement to a corresponding heavy duty vehicle's data bus data link connector. Note that receptacle 3 further includes openings (e.g. slots) 3f, in flange 3d—which in installations not requiring sleeve 1, correspond to vehicle chassis mounting apertures and facilitate jointing of the receptacle 3 to the vehicle chassis.

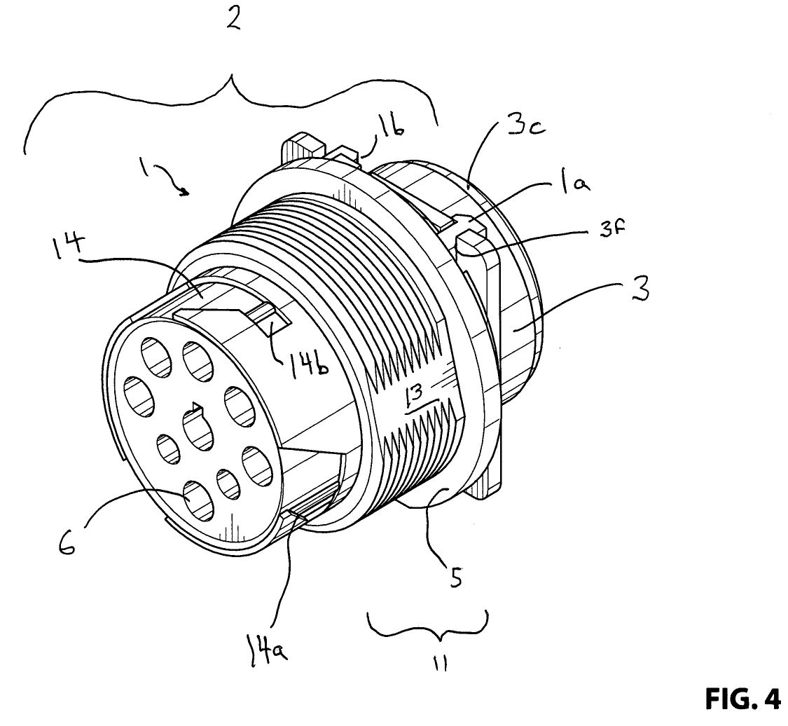

Sleeve 1 is adapted to be slidably mounted into cooperative engagement in conjoined, axially and radially fixed relation on receptacle 3 (see in particular, the assembly shown in FIG. 4) with the sleeve's flange 5 engagable in flange-matching chassis-secured relation adjacent the vehicle chassis mounting aperture with the receptacle 3 supported thereby in pass-thru relation with the aperture.

Divers means for mutually securing the sleeve to the receptacle are within the contemplation of broader aspects of the present invention, and might include welding, chemical bonding, screws, or other such like. However, particular advantages accrue when the securing means comprises one or more processes (e.g. pin 1a) extending from sleeve 1 which are adapted to engage in conjoined axially and radially fixed relation with receptacle flange 3d. Processes 1a are advantageously arranged to engage in aligned locking registration thorugh corresponding receptacle 3 slots 3f, with tabs lb engaged in axial-withdrawal resisting relation against the rear side of flange 3d. This provision or cooperating mechanical members co-joins the sleeve 1 with receptacle 3 in a mutually fixed mechanical relation.

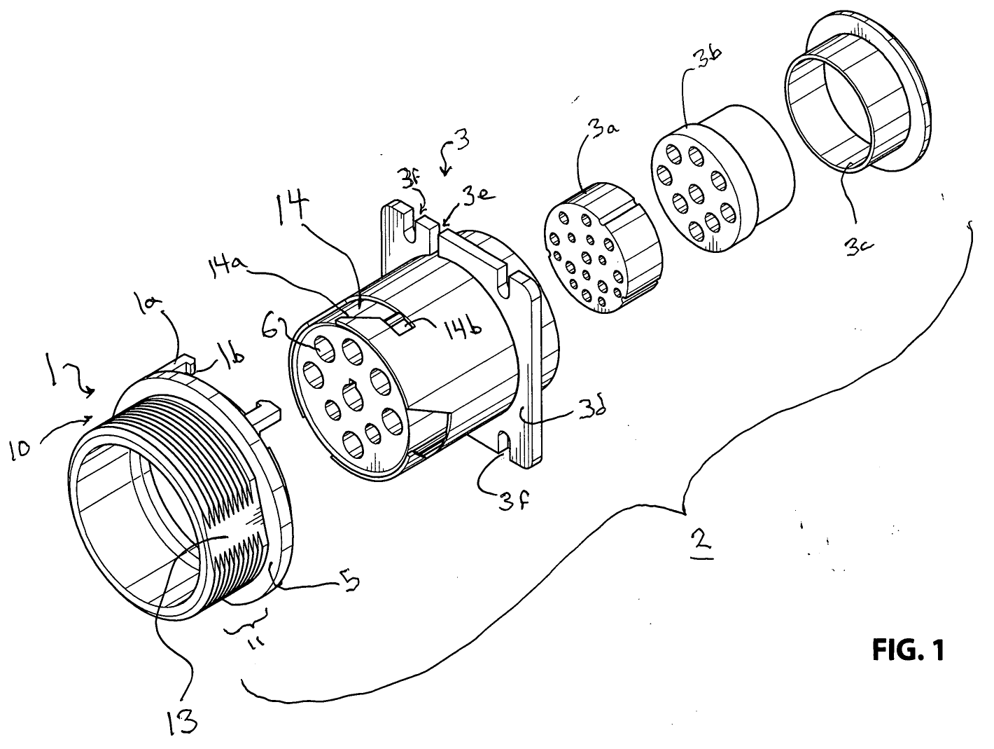

In the embodiment according to FIG. 1, sleeve 1 comprises flange 5 as a radially outward extension from the outer circumference of sleeve 1. Sleeve 1 also includes threads 10 arranged over at least a portion 11 of the outer circumferential surface of sleeve 1. Threads 10 are adapted for axially engaging a jam nut (not shown) in threaded relation thereon and co-operable therewith to secure the vehicle chassis mounting between the flange 5 and that nut.

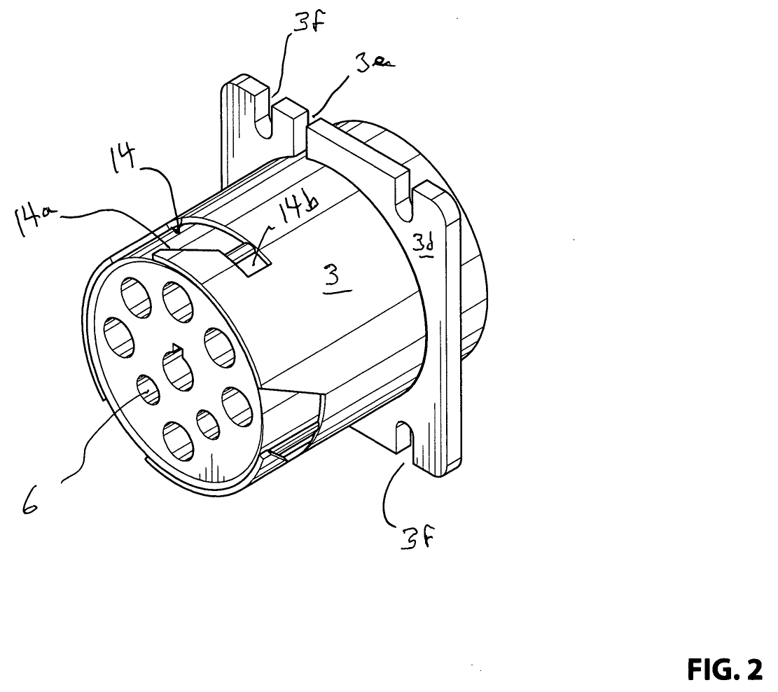

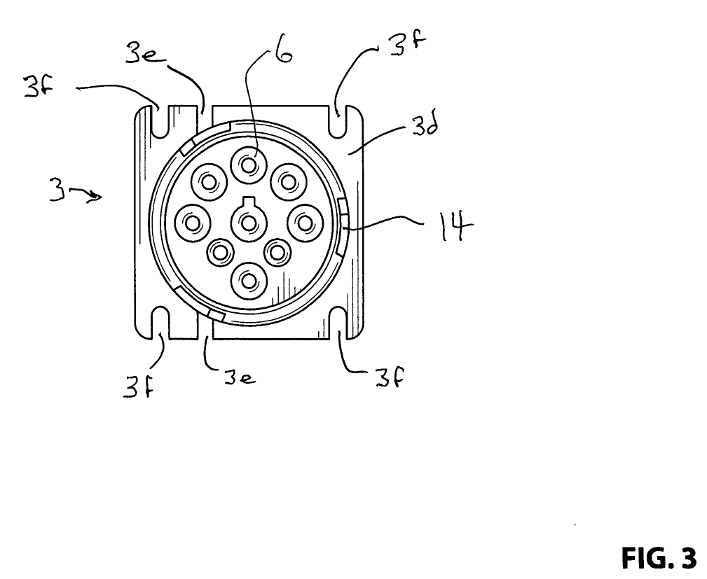

FIGS. 2, 3 and the present invention in general, relate to alternative flange mounting for cylindrical receptacles, notionally referred to as Deutsch receptacles associated with their conventional use in heavy duty vehicles data communication links. These are often associated with various standards. SAE 31587 for example is a diagnostic protocol standard developed by the Society of Automotive Engineers (SAE) for heavy-duty and most medium-duty vehicles built after 1985. Up to 1995, individual OEMs used their own connectors. From 1996 to 2001, the 6-pin Deutsch was standard. Beginning in 2001, most OEMs converted to the 9-pin Deutsch. Some OEMs still use the 6-pin Deutsch. SAE 31708 is an SAE physical specification developed especially for heavy duty vehicles (trucks and buses). The protocol promoted a standard for serial communication between modules with microcontrollers. 31708 describes the physical and data link layer. Almost always used in conjunction with the application layer protocol SAE 31587. SAE 31939 In the early 90's, the SAE Truck and Bus Control and Communications Sub-committee started the development of a CAN-based application profile for in-vehicle communication in trucks. In 1998 the SAE published the 31939 set of specifications. A 31939 network connects electronic control units (ECU) within a truck and trailer system. The 31939 specification—with its engine, transmission, and brake message definitions—is dedicated to diesel engine applications. 31939 is intended to supplant 31587/31708 networks. SAE 31939 has been adopted widely by diesel engine manufacturers. One driving force behind this is the increasing adoption of the engine Electronic Control Unit (ECU), which provides one method of controlling exhaust gas emissions within US and European standards. Consequently, SAE 31939 can now be found in a range of diesel-powered applications: vehicles (on- and off-road), marine propulsion, power generation and industrial pumping. In this regard, examples of receptacles applicable in relation to the present invention would be those useful in 9 pin Deutsch 31939 type 1 or type 2 connector receptacles; 9 pin Deutsch PACCAR connector receptacles; 9 Pin Deutsch CAT industrial connector receptacles; 9 pin Deutsch SAE Standard Heavy Duty truck connector receptacles, as well as 6 pin Deutsch 31708/31587 heavy duty truck connector receptacles used in older truck models.

In particular, the present invention relates to receptacles having integral flanges (see for example ref. numeral 3d with slots 3f),adapted for vehicle chassis mounting on receptacle flange compatible vehicles—but for which a sleeve arrangement is provided to facilitate alternative coupling mounting on such vehicle chassis through a flanged sleeve of a sleeve/receptacle combination for use on vehicles that are not otherwise receptacle flange compatible.

Referring still to FIGS. 2 and 3, there is shown perspective and elevated end plan views of receptacle 3. Note in particular the “twist-lock” features 14 of receptacles 3 in this embodiment. These are known features associated with Deutsch connectors commonly used for interfacing with vehicular diagnostic scan tools which have cooperative plugs adapted to engage with the receptacles that include a twist-lock collar and associated channel followers that bear against cam faces of channel feature 14 when the collar is twisted to ensure proper axial seating of the plug into the receptacle. The turning of the collar, in known manner, results in the application of torque to the receptacle. In accordance with the present invention, receptacle 3 is adapted in known manner with channel features 14, including cam faces 14a and channel feature stops 14b. Corresponding, and also known, compatible plugs are axially seated into the receptacle by way of a rotating twist-lock collar (not shown) having channel cam followers (also not shown) within receptacle channel features 14. As a result of such rotation, the channel followers can act against a cam surface 14a of channel feature 14 of receptacles 3 to rotatingly leverage (draw) the plug into axial connected axial engagement with receptacle 3 with the channel cam followers ultimately bearing against the channel stop 14b. Torque exerted on the receptacle 3 in this way, must be resisted to prevent relative rotation between receptacle 3 and sleeves 1 or 1a as the case may be.

Referring now to FIG. 4, there is illustrated an elevated side view assembly of the embodiment shown in FIG. 2, in which sleeve 1a with flange 5 is shown positioned on receptacle 3. Coupling 2 includes sleeve 1 with flange 5 surrounding receptacle 3 and helps to also illustrate a flat 13. Flat 13 provides optional means for securing the sleeve in non-rotating relation relative to the dashboard and may also facilitate clearance for insertion of the sleeve into the chassis mounting aperture.

Sleeve 1a is shown in mounted relation with flange 5 on receptacle flange 3d, with a view of bores 6. Note in particular, the representation of slotted key openings 3e in receptacle flange 3d. Slotted openings 3e are advantageous in securing the aligned fit between sleeve 1 and receptacle 3 through a corresponding key (not shown) on flange 5, which is adapted to mechanically engage with slotted key opening 3e and amongst other things, resist torsional movement of sleeve 1 relative to receptacle 3 during connection/disconnection of the scan tool or other peripheral device.

In addition, in accordance with the illustrated arrangement of the elements as shown in FIG. 4, the torque mentioned above in relation to the seating of the compatible plug (by way of a rotating collar acting on a cam surface of said receptacle to rotating draw said plug into axial connected axial engagement with said receptacle, and wherein torque exerted by rotation of said collar during axial engagement thereof into said receptacle), urges said pin 6 against said closed end 20a in said relation therewith to generally prevent relative rotation between receptacle 3 and pins 1 or 1a as the case may be.

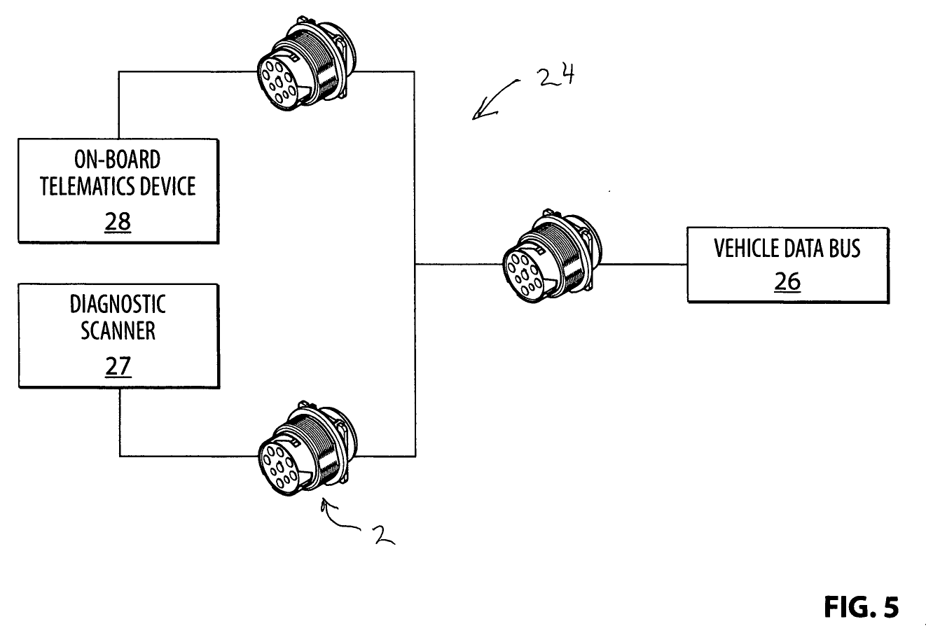

Referring now to FIG. 5, there is illustrated a coupling according to the present invention in combination with a T or Y type wiring harness 24, connected at one end to a vehicle data link connector (DLC) not shown, that is associated with a vehicle's data bus 26. Coupling 2 is connected to a plug and associated diagnostic tool 27. The other branch of the wiring harness 24, is connected to an on-board telematics device 28 (often an after-market installation which is facilitated though the use of the multi-branched wiring harness 24).

1. An alternative sleeve-flanged vehicle-mounting sleeve for use in association with a heavy duty vehicle, chassis-mountable, data bus signal wiring harness coupling which further includes a receptacle:
said receptacle having a generally circular cross-section and being adapted to be accommodated in longitudinal pass-through relation by a corresponding vehicle chassis mount including a mounting aperture for said coupling; and, having a plurality of conductor-receiving, longitudinally-extending bores adapted to be selectively populated by data bus signal wiring and associated contact terminals corresponding in numbering and arrangement to a corresponding heavy duty vehicle's data bus data link connector; and, a receptacle-flange engagable in receptacle-flange matching chassis-secured relation with a compatible receptacle-flange chassis mount adjacent said vehicle chassis mounting aperture with said receptacle supported thereby in pass-thru relation with said aperture; and,
said sleeve being adapted to be slidably mounted into cooperative engagement in conjoined, axially and radially fixed relation on said receptacle with said alternative sleeve-flange engagable in flange-matching chassis-secured relation adjacent said vehicle chassis mounting aperture with said receptacle supported thereby in pass-thru relation with said aperture.

2. The sleeve according to claim 1, wherein said sleeve and said receptacle are adapted to be conjoined in fixed mechanical relation by at least one cooperative member and a corresponding cooperative member engaging surface on respective ones of said sleeve and said receptacle.

3. The sleeve according to claim 2, wherein said sleeve and said receptacle include a plurality of respective cooperative members.

3. The sleeve according to claim 2, wherein a sleeve member is adapted to engage in said conjoined relation with a corresponding cooperative member engaging surface of said receptacle flange.

4. The sleeve according to claim 3, wherein said sleeve member comprises a pin, and said cooperative member engaging surface of said receptacle comprises a sleeve pin member engaging member on said receptacle flange.

5. The sleeve according to claim 1, wherein said receptacle is adapted to engage with a compatible plug by way of a rotating collar acting on a cam surface of said receptacle to rotating draw said plug into axial connected axial engagement with said receptacle.

6. The sleeve according to claim 1, wherein said sleeve includes threads arranged over at least a portion of said sleeves outer circumferential surface for axially engaging a jam nut in threaded relation thereon and co-operable therewith to secure said chassis mounting between said sleeve flange and said nut.

7. A heavy duty vehicle, chassis-mountable, data bus signal wiring harness coupling comprising a receptacle and a flanged vehicle-mounting sleeve, according to claim 1.

8. A set comprising a receptacle and at least one alternatively-flanged sleeve according to claim 1.

9. One or more couplings according to claim 1, in association with one or more of a plurality of wiring harness termini respectively adapted to provide wiring connections to a corresponding plurality of after-market vehicle data bus accessing devices, wherein at least one of the termini is adapted to be associated with a vehicle's OEM provision for the vehicle chassis mounted coupling, and said wiring harness includes a common connection with the vehicular data bus link connector, and various termini respectively serving connections with the divers aftermarket devices.
